(19) United States
(12) Patent Application Publication
(10) Pub. No.: US 2006/0277044 A1
(43) Pub. Date: Dec. 7, 2006

(54) Client-based speech enabled web content

(76) Inventor: Martin McKay, Belfast (IE)

Correspondence Address: Brian L. Michaelis, Esq.;Brown Rudnick Berlack Israel LLP, One Financial Center, Boston, MA, 02111, US

(21) Appl. No.: 11/143,125

(22) Filed: Jun. 2, 2005

(51) Int. Cl. G10L 13/08

(52) U.S. Cl. 704/260

(57) ABSTRACT

A system for client-based speech enabled web content is disclosed. A client-side software program is free to download and the website owner or content provider subscribes to the service to speech enable their website content. The visitor downloads a small browser plug-in free from the enabled site. The system allows visitors the option of having website content read to them. As the website visitor moves the cursor over text, it is spoken aloud. The users have control over the voice, word pronunciations and speech highlighting. The system reads static and dynamic content on the fly rather than creating recorded sound files. The user can read text in the order that they want and is not forced to read the text on every page of a website. Other functionality include dual color highlighting, continuous read option, webmaster pronunciations control, and multi-lingual capabilities.

### TECHNICAL FIELD

The present disclosure relates generally to web accessibility and more particularly to client-based speech enabled web content.

### BACKGROUND OF THE INVENTION

“Web Accessibility” involves ensuring all users, regardless of physical and mental capability, have access to the content and services on websites. It is a common practice when developing accessible websites to only focus on the considerations for the population that are blind. Little consideration is given to the far greater number of people who struggle to read, either due to poor literacy levels in English or some sort of reading related disability. Like the blind grouping, individuals from this group come from a wide cross section of the general population, but unlike the blind grouping, this group is much larger in size and a significant proportion come from a poorer socio-economic background. Those that are blind will typically have a solution in place in order to achieve on-line independence. People in the “print challenged group” do not typically have access to screen-reading technology and in many cases may not even be aware of its existence.

In the past, when an individual was unable to read electronic text, use was usually made of a human reader. Today, synthesized speech reading of text by a “talking” computer provides a low cost alternative which allows users to listen to text as well as (or instead of) reading from the screen. Reading text aloud benefits anyone having difficulty reading information on a computer screen and those for whom simultaneously hearing and reading text aids comprehension. Hearing the text on a website spoken by the computer is an alternative way to access information and can provide site visitors with more independent access to the site content itself.

Present web speech enabling technologies, however, rely on creating recorded sound files. These systems, unfortunately, require large bandwidths and are impractical with dynamically generated web content such as search engines or shopping baskets. The sound files have to be laboriously updated whenever changes to the website are made. In addition, there are limitations on adjustability of the audio recorded. Prior art systems suffer from other problems such as having no visual indication of the text being spoken, or forcing the user to read the whole page of a website.

The prior art generally lacks the ability to empower a website visitor with the tools required to understand website content and successfully interact with the website.

### SUMMARY OF THE INVENTION

According to the present invention the problems associated with prior art applications are solved by an accessibility service and system that provides client-based speech enabled website content. The system allows website visitors the option of having website content read to them. As the visitor moves the cursor over text, the text is highlighted and spoken aloud. The user has control over the voice, word pronunciations and speech highlighting. The system reads static and dynamic content on the fly and therefore eliminates the need for recorded sound files. The user can read text in the order that they want, and the system automatically speaks new content when the website is updated.

A client-side software program (a small browser plug-in) is free for the visitor to download from the enabled site and there is zero bandwidth impact after initial download. The website owner subscribes to the service in order to speech enable their website content, and a webmaster has no additional software to install on a web server. The process of making the site speech enabled is seamless and handled remotely so downtime and management overhead costs are eliminated or minimal. The system assists users with low literacy and reading skills or where English is not the first language. It also aids the dyslexic community and those with mild visual impairment.

Dual color highlighting is provided. As each word or paragraph is spoken aloud to the user, each word is highlighted thus delivering content on two levels, written and auditory. By color highlighting text as it is being read, audio-visual reinforcement occurs which helps to develop recognition of new words and vocabulary. Additionally, the color used is definable for each user, providing a solution to readers for whom color presents a problem, such as dyslexics who struggle to comprehend black text on a white background.

The system can speak website content in various languages including Dutch, French, Spanish, German, Italian, Japanese, Korean, Portuguese and Russian (as long as the content is published in the particular language). Auto continuous reading provides the user with the ability to have all the content read aloud to them without any user interaction. This is of major benefit to users who have trouble using a pointer device. The user can specify male, female or US, UK and European voices and the user can also specify pitch, speed and volume of the speech. The webmaster can modify pronunciations for all users and/or define a preferred voice or language for a given URL, thereby aiding with the overall comprehension levels.

The system can read Alt Tags, Accessible Flash and Java, PDF documents and forms. The content of drop down lists can be read as the mouse is passed over them, and the system can read the content of text boxes on forms after the user has typed into them. The system is able to read dynamic HTML and “fly out” menus as the mouse is passed over them, and able to read “ticker text” as it scrolls, as well as text generated by JavaScript after the page has loaded. Text secured by https such as credit card numbers can also be read without any data leaving the local computer.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

The foregoing features and advantages of the present invention will be understood by reference to the following description, taken in connection with the accompanying drawings, in which:

FIG. 1 is a view of client-based speech enabled web content in accordance with the principles of the present disclosure;

FIG. 2 is a view of the hierarchy of functional groupings within a client application;

FIG. 2A is a view of a Speech tab associated with an options panel of the client application of FIG. 2;

FIG. 2B is a view of a Pronunciations tab of the options panel of FIG. 2A;

FIG. 2C is a view of a Settings tab of the options panel of FIG. 2A;

FIG. 2D is a view of an About tab of the options panel of FIG. 2A;

FIG. 2E is a view of a system tray icon included in the client application of FIG. 2;

FIG. 2F is a view of the system tray icon of FIG. 2E with a tick superimposed;

FIG. 2G is a view of a site verification and enable process associated with the present invention;

FIG. 2H is a view of a text retrieval and pronunciation process associated with the present invention;

FIG. 2I is a view of a speech engine and highlight process associated with the present invention; and

FIG. 3 is a view of the hierarchy of functional groupings within a server application.

### DETAILED DESCRIPTION

An illustrated embodiment of the client-based speech enabling method and apparatus disclosed is discussed in terms of an accessibility application that allows website visitors the option of having website content read to them.

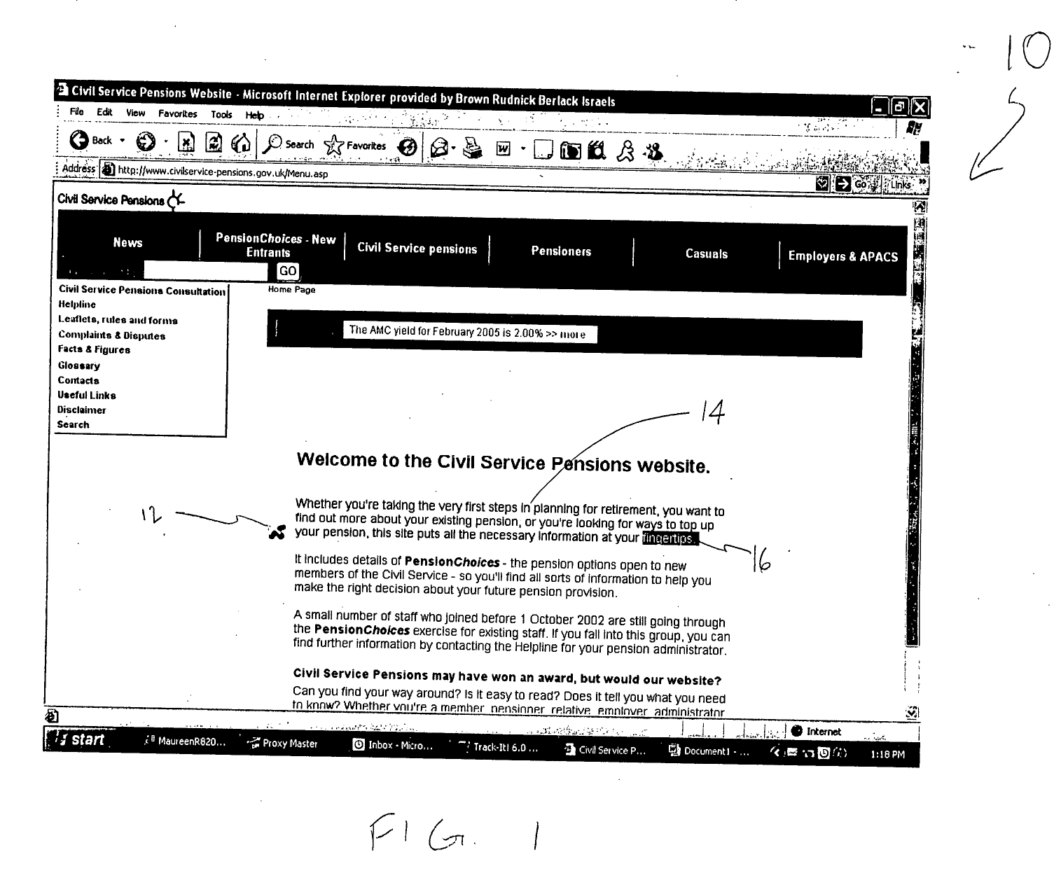

Referring now to FIG. 1, upon reaching a website 10 which is speech enabled, the website visitor is alerted that the content is speech enabled. The visitor is then directed to a download location where they download a small browser plug-in for free. The plug-in is installed in one step. Upon return to the website, the software automatically detects the website URL and “switches on” the speech enabling application. As the website visitor moves a cursor 12 over screen text, this text is automatically highlighted and spoken aloud to the visitor. In the illustrative embodiment, one color is used for highlighting the paragraph of text 14 and a different color is used to highlight each word 16 of the paragraph as that word 16 is being spoken.

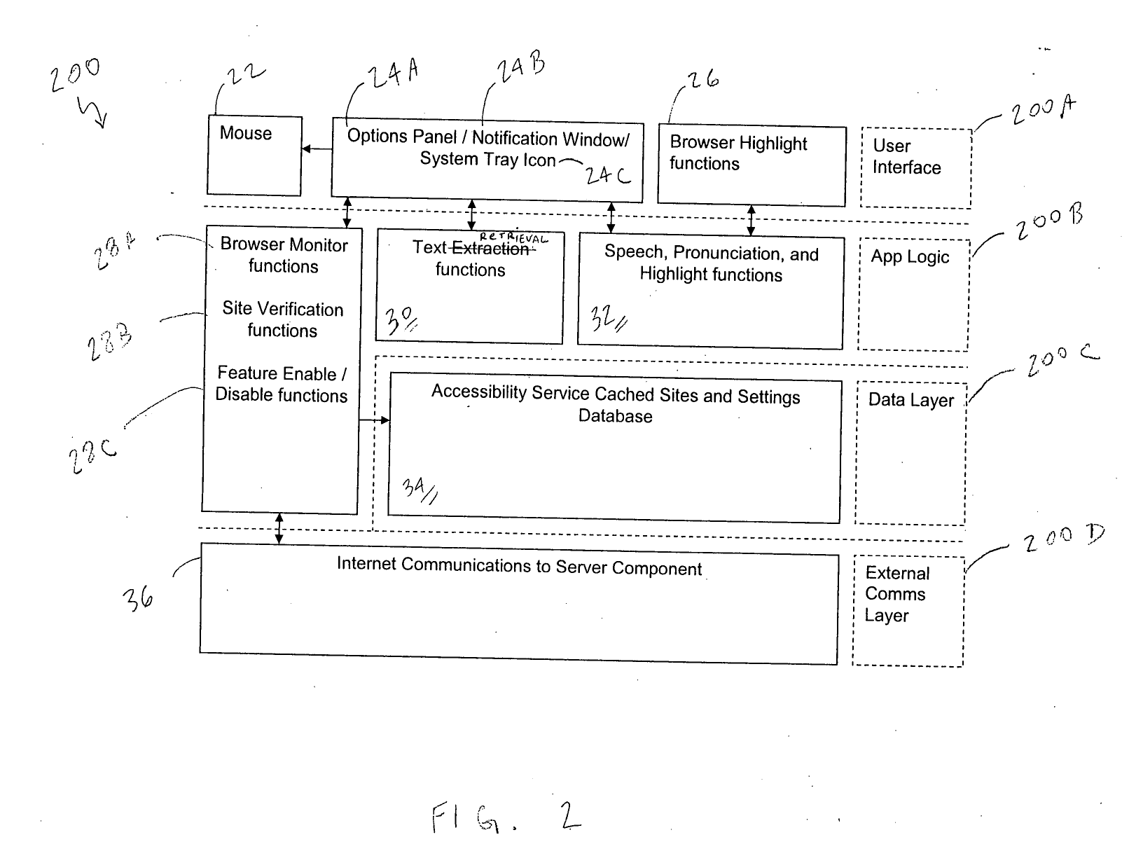

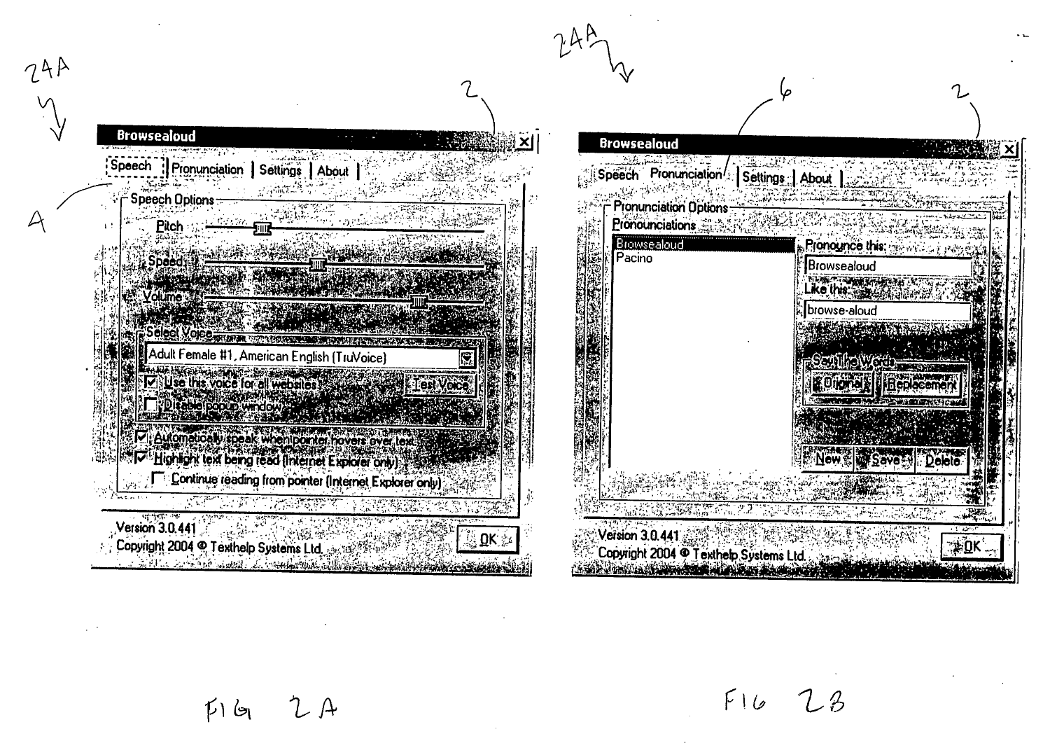

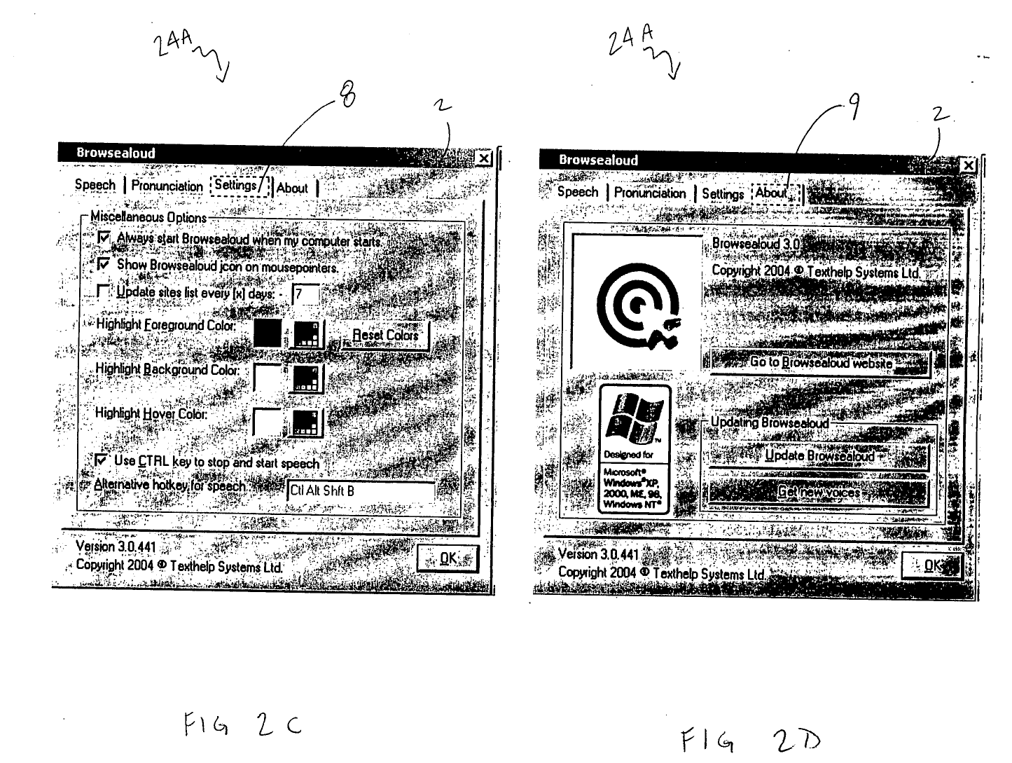

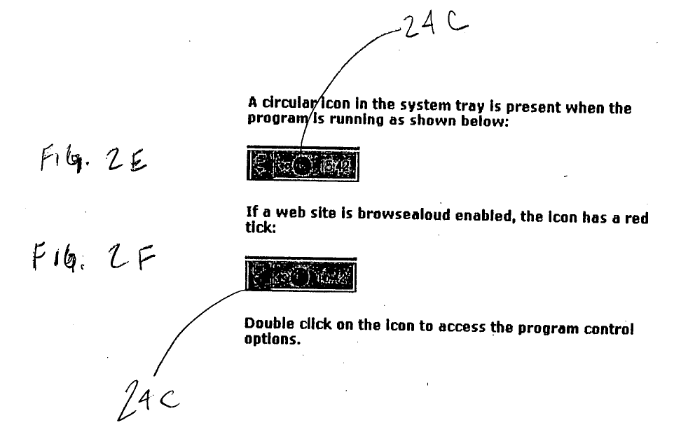

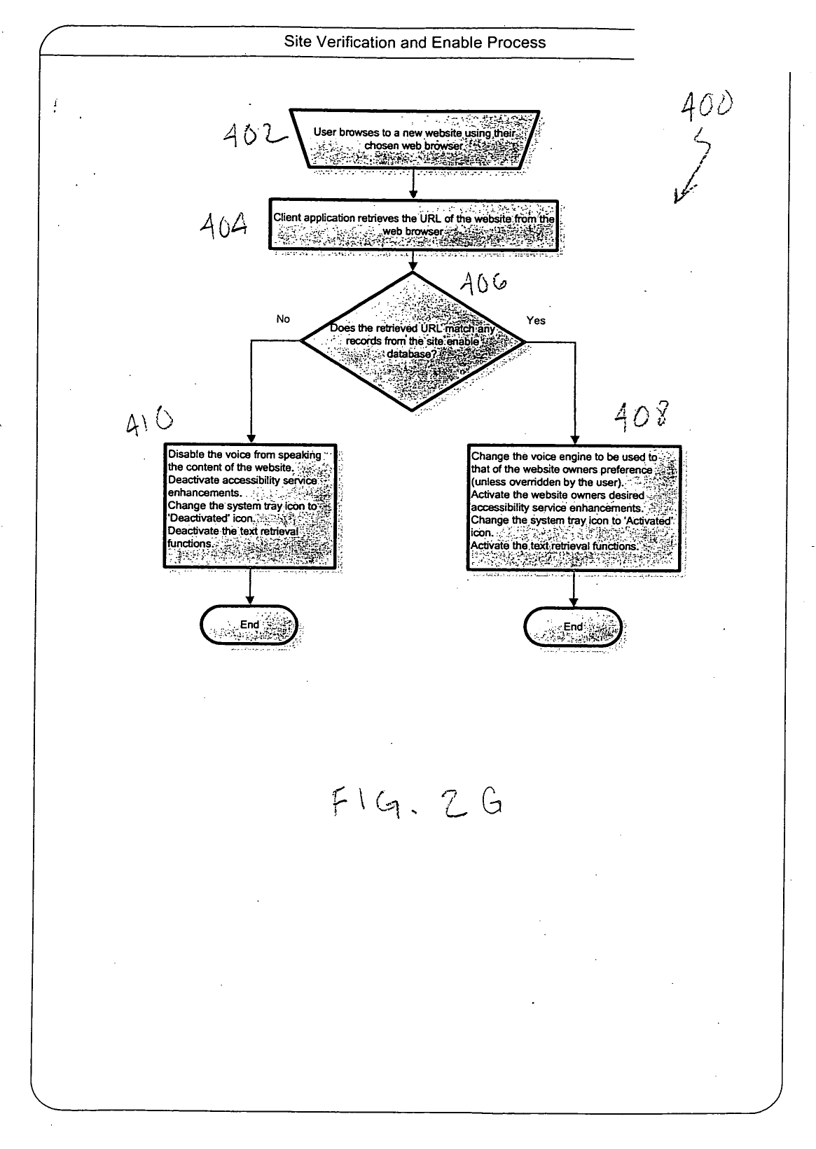

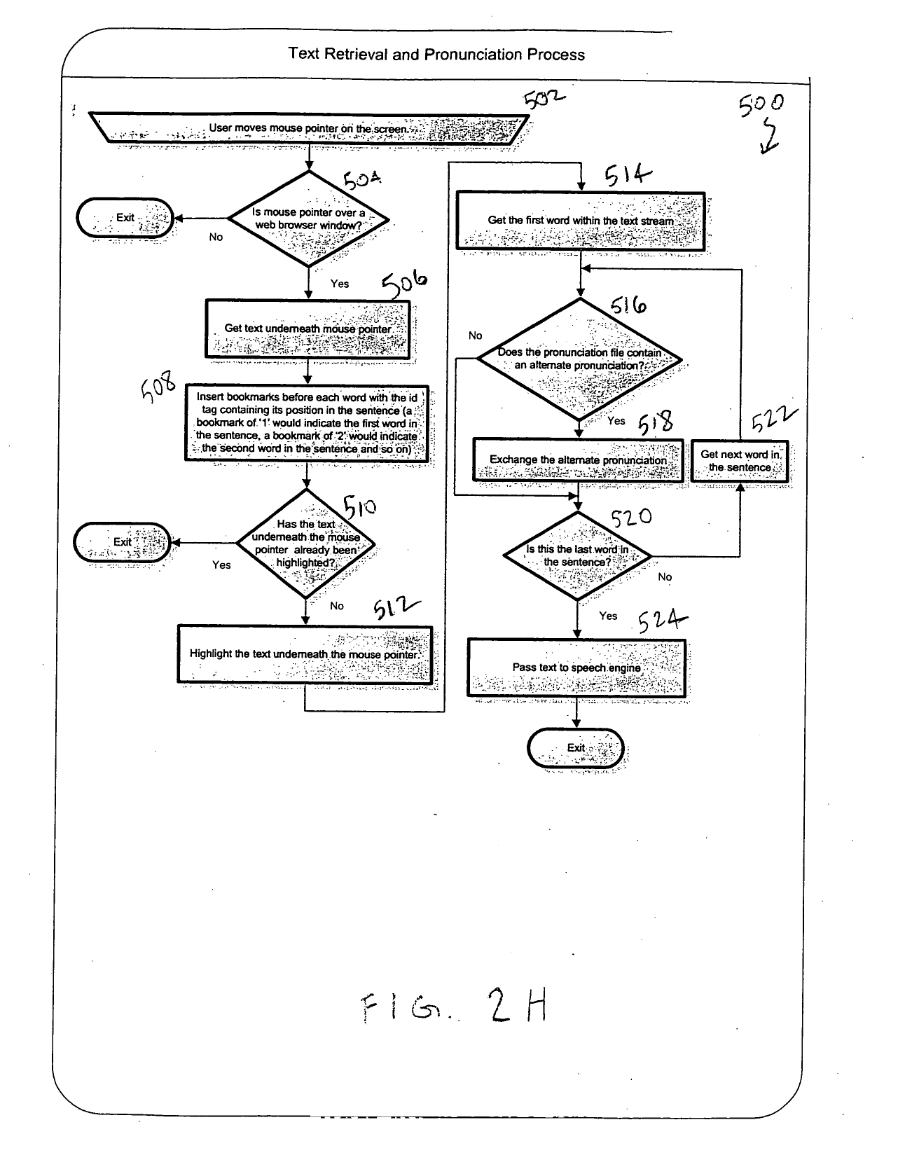

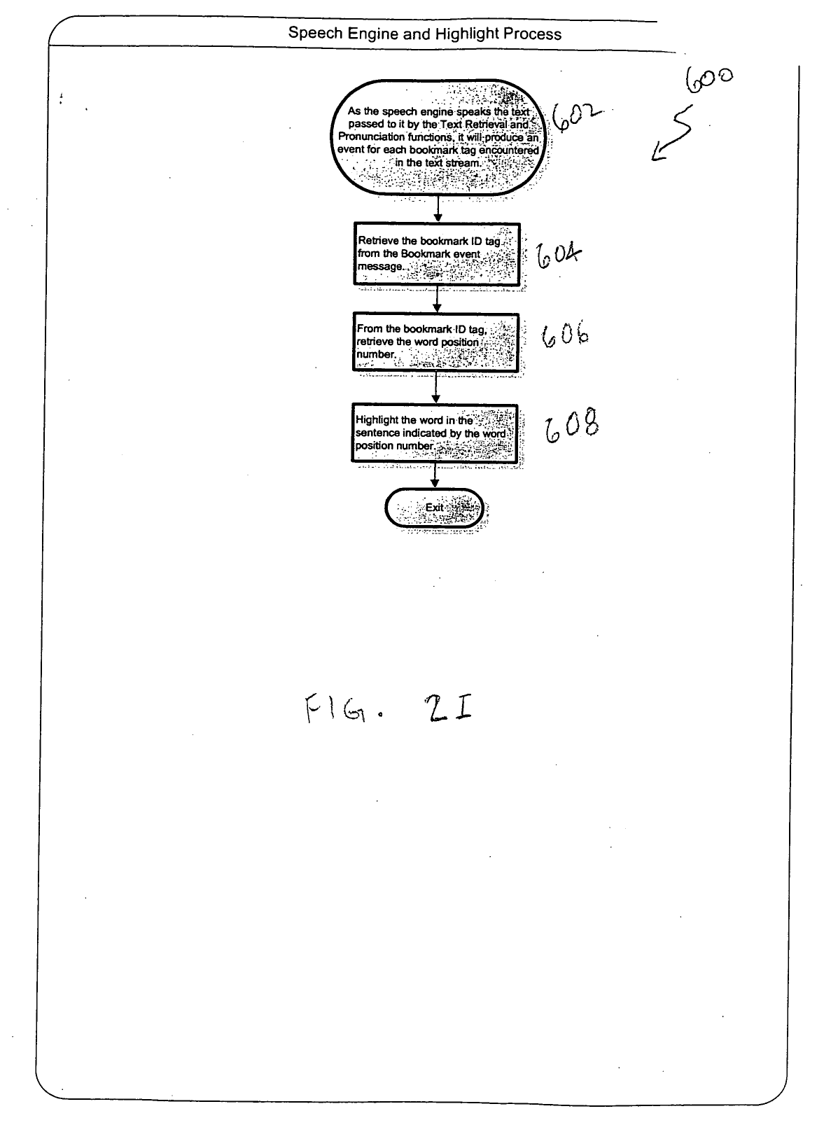

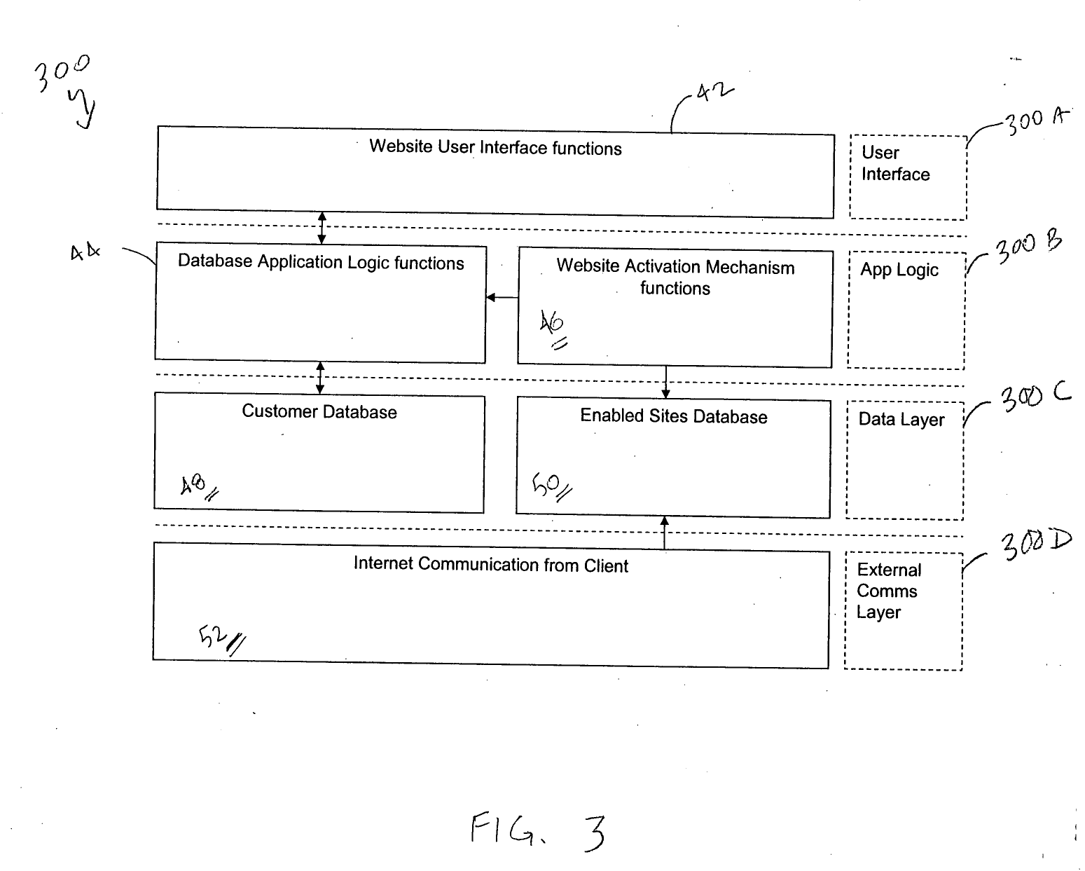

Referring now to FIGS. 2 and 3, there is illustrated an overview of an apparatus for providing client-based speech enabled website content, constructed in accordance with the principles of the present disclosure, and referred to specifically as an “accessibility application.” The accessibility application provides accessibility enhancements to customer websites on a subscription basis. The accessibility application includes two software components, for example, a client application 200 (FIG. 2) and a server application 300 (FIG. 3).

The client application 200, as shown in FIG. 2 and later described in greater detail, has the following functionalities. Application 200 has the ability to request and download information from the server application 300 (FIG. 3). This is done via internet communications to server component 36 located within an external communications layer 200D. This information includes, for example, the websites subscribed to the accessibility service, the accessibility enhancement settings for each website and a current version of the client software.

Client application 200 also has the ability to provide accessibility enhancements to the user's browser. These enhancements include selecting the text to be spoken within the web browser application by simply moving a mouse pointer 22 over the desired text, and speaking and highlighting the text selected by the user. Other enhancements include substituting alternative phonetic pronunciations for individual words when the selected text is currently being spoken, as well as switching and modifying the voice being used to read selected text. The client application 200 can also silently activate, modify and deactivate enhancements based on settings downloaded from the server application 300 of FIG. 3.

The server application 300, as shown in FIG. 3 and later explained in greater detail, provides functionality that allows an administrator to add and modify the details of resellers or reseller customers. The administrator can also enable, modify and disable accessibility features for websites belonging to reseller customers. Similarly resellers of the accessibility service are able to add and modify the details of their customers or enable, modify and disable accessibility features for websites belonging to their customers. Customers subscribed to the service can enable, modify and disable accessibility features for their websites. The server application 300 provides, to any client application 200 requesting it, information such as websites subscribed to the service, accessibility enhancement settings for each website, and a current version of the client software. This is performed via an internet communication from client section 52 at an external communications layer 300D.

FIG. 2 is a diagram detailing the hierarchy of the relevant functional groupings or objects within the client software application 200. The client application 200 can be a single tier desktop application and is modular to accommodate changes and additions. In conjunction with a user interface layer 200A, a mouse 22 or other suitable means and browser highlight functions 26 are provided to allow a user to point, activate screen buttons, select text, etc. A Data Layer 200C includes an Accessibility Service Cached Sites and Settings Database 34 for storing information such as the website address details of activated sites and the individual settings for accessibility features for activated sites.

An options panel 24A, as shown in FIGS. 2A-2D, is provided. Options panel 24A consists of a form 2 with four tabs 4, 6, 8, 9 each having controls which control the options for ‘Speech’, ‘Pronunciation’, ‘Settings’, and ‘About’. The form 2 has minimize and maximize buttons to minimize and maximize the form and a “close” button to minimize the application to the system tray.

The speech tab 4 (FIG. 2A) includes a ‘select voice’ box used to enumerate speech engines resident on the machine and allow the user to select their preferred voice. ‘Pitch’, ‘Speed’ and ‘Volume’ functions adjust the characteristics of the currently selected voice according to user preference. A ‘Test Voice’ button sends a sentence to the speech functions so that the user can verify that they have modified the voice to their preference. A ‘Use this voice for all websites’ checkbox tells the client to override the website settings and use the currently selected voice and associated settings for all websites registered with the accessibility service. A ‘Disable popup window’ checkbox tells the client to disable the popup notification window when a new update for the client appears on the accessibility service website. An ‘Automatically speak when mouse hovers over text’ checkbox tells the client to automatically start speaking the text under that mouse pointer 22 when the specified ‘time-before-speak’ delay time has passed.

The ‘Pronunciations’ tab 6 (FIG. 2B) includes a ‘Pronunciations’ list box that lists words to be replaced with a replacement phonetic spelling when they are sent to the speech engine. For example, in the case of the words ‘Al Pacino’, the word ‘Pacino’ could be replaced by the word ‘Pachino’. A ‘Pronounce this’ textbox is provided to enter the word to be replaced, and a ‘Like this’ textbox is provided to enter the word replacement. ‘Say the words’ buttons are provided and include an ‘Original’ button that says the original word to be replaced, and a ‘Replacement’ button that says the replacement word. A ‘New’ button creates a new pronunciation replacement setting, a ‘Save’ button saves a new pronunciation replacement setting, and a ‘Delete’ button deletes a pronunciation replacement setting.

The ‘Settings’ tab 8 (FIG. 2C) includes an ‘Always start Browsealoud when my computer starts’ checkbox. When checked it creates a registry setting to allow the speech enabling software to start when the system boots up, and deletes the setting when it is unchecked. A ‘Show Browsealoud icon on mousepointers’ checkbox changes the mouse pointer 22 into a yellow arrow or other symbol when the mouse pointer 22 is hovering over activated content, and change it back when the pointer 22 is not hovering over activated content. This behavior will be disabled if the checkbox is unchecked. An ‘Update site list every [x] days’ checkbox tells the system to update the ‘Cached Sites and Settings’ database (discussed below) so that newly activated sites can be activated when they are added to the activation database by the server application 300. An ‘X Days’ checkbox tells the system to wait an interval of ‘X’ days from the last update to when the ‘Update site list every [x] days’ checkbox is checked.

A ‘Highlight Foreground Color’ color palette control alters the color used to highlight the text selected by the user. A ‘Highlight Background Color’ color palette control alters the color used to highlight the background of the text currently being spoken. A ‘Highlight Hover Color’ color palette control alters the color used to initially highlight the selected text before it is spoken. A ‘Use CTRL key to stop and start speech’ checkbox tells the system that when a CTRL key of a keyboard is pressed, stop the speech if it is currently being spoken, and start to speak the selected text if the ‘Automatically speak when mouse hovers over text’ checkbox is not checked. An ‘Alternate hotkey for speech’ textbox allow the user to define an alternative hotkey to the CTRL key.

The ‘About’ tab 9 (FIG. 2D) includes a customer logo, and the accessibility service (“service”) logo. An ‘Update Browsealoud’ button updates the Cached Sites and Settings database 34 when pressed. A ‘Get new voices’ button calls up a browser and redirects it to a voice download page so the user can download new voices when they become available. A ‘Go to Browsealoud website’ button calls up a browser and redirects it to the service provider site so that the user can find out new and information concerning the service.

Referring again to FIG. 2, the user interface 200A further includes a notification panel 24B. The notification panel 24B includes a window (not shown) that appears at the bottom left hand corner of the screen when an update to the client has been published on the Internet, or when an error has occurred. The window disappears when the user acknowledges the notification by clicking on the window.

A system tray icon 24C is provided within the system tray notification of the start bar. The appearance of the icon 24C can change. For example, when the user browses to an activated website or webpage from an unactivated site or webpage, the icon 24C changes to a icon with a tick superimposed thereover, as shown in FIG. 2F. When the user browses to a deactivated website or webpage from an activated site or webpage, the icon 24C changes to an icon with no tick superimposed thereover, as shown in FIG. 2E. If the user right clicks on the icon 24C within the system tray area of the toolbar, a popup menu appears in the bottom left hand corner with options to enable or disable automatic speech, display the options panel or go to the accessibility service website. If the user double clicks on the icon 24C within the system tray area of the toolbar, the options panel 24A (FIGS. 2A-2D) will be displayed.

Referring again to FIG. 2, an application logic layer 200B includes Browser Monitor Functions 28A, Site Verifications Functions 28B and Feature Enable/Disable Functions 28C. These Functions 28A, 28B, 2C are now described with reference to FIG. 2G which illustrates one embodiment of a site verification and enable process 400. In step 402, the user browses to a new website using their chosen web browser. Applying the Browser Monitor Functions 28A, the client application 200 in Step 404 retrieves the URL of the website from the web browser. In Step 406, the Site Verification Functions 28B determine whether the retrieved URL matches any records from the cached sites and settings database 34 (FIG. 2). If it is determined that the retrieved URL matches a record from the database 34, then in Step 408 the Feature Enable/Disable Functions 28 change the voice engine to be used to that of the website owner's preference (unless overridden by the user). Also, the website owner's desired accessibility service enhancements are activated, the system tray icon 24C is changed to the “Activated” icon (FIG. 2F) and the Text Retrieval Functions 30 (explained below) are activated.

If it is determined that the retrieved URL does not match a record from the database 34, then in Step 410 the Feature Enable/Disable Functions 28 disable the voice from speaking the content of the website and deactivate the accessibility service enhancements. Also, the system tray icon 24C is changed to the “Deactivated” icon (FIG. 2E) and the Text Retrieval Functions 30 are deactivated.

FIG. 2H illustrates a text retrieval and pronunciation process 500 used if the retrieved URL has been matched and the Text Retrieval Functions 30 have been activated as described above (FIG. 2G Step 408). In Step 502 a user moves the mouse pointer 22 on the screen. It is determined in Step 504 whether the mouse pointer 22 is currently over a web browser window. If the mouse pointer 22 is not over the browser window, the process 500 is exited. If the mouse pointer 22 is over the browser window, the Text Retrieval Functions 30 in Step 506 capture the text underneath the mouse pointer 22. In Step 508, the Text Retrieval Functions 30 insert bookmarks before each word with an ID tag marking its position in a sentence. For example, a bookmark of “1” would indicate the first word in the sentence, a bookmark of “2” would indicate the second word in the sentence and so on.

Referring still to FIG. 2H, it is determined in Step 510 whether the text underneath the mouse pointer 22 has already been highlighted. If it is determined that the text underneath the mouse pointer 22 has already been highlighted, the process 500 is exited. If it is determined that the text underneath the mouse pointer 22 has not already been highlighted, the Speech, Pronunciation and Highlight (“SPH”) Functions 32 in Step 512 perform initial highlighting of the text underneath the mouse pointer 22.

In the next Step 514, the SPH Functions 32 get the first word within the text stream. In Step 516, it is determined whether a pronunciation file contains an alternative pronunciation for the first word. If the pronunciation file contains an alternative pronunciation for the first word, the SPH Functions 32 in Step 518 exchange the alternative pronunciation (for the first word's default pronunciation). If it is determined that the pronunciation file does not contain an alternative pronunciation for the first word, it is then determined in Step 520 whether that word is the last word in the text stream. If it is determined that the word is not the last word in the text stream, the SPH Functions 32 in Step 522 evaluate the next word in the text stream as described above. This process is repeated until the last word in the text stream is evaluated. Thereafter, the text is passed to the speech engine in Step 524 and the process 500 is exited.

FIG. 2I illustrates a speech engine and highlight process 600 used to highlight individual words in the text as they are spoken by the speech engine. In Step 602, as the speech engine speaks the text passed to it by the text retrieval and pronunciation process 500, an event, such as, for example, a bookmark event message is produced for each bookmark ID tag (FIG. 2H Step 508) encountered in the text stream. In Step 604, the bookmark ID tag is retrieved from the bookmark event message. In Step 606, the word position number is retrieved from the bookmark ID tag. In Step 608, highlighting of the word in the text stream indicated by the word position number is performed and the process 600 is exited.

FIG. 3 is a diagram detailing the hierarchy of the relevant objects/functional groupings within the server application 300. Server application 300 can be a three tier application and is modular to accommodate changes and additions. The server application 300 includes a website user interface 42. At the applications logic layer 300B, a database application logic functions 44 as is known in the art and a website activation mechanism 46 are provided. At a data layer 300C, there are a customer database 48 and enabled site database 50. At an external communications layer 300D, an internet communication from client section 52 is provided for processing communications from the client application 200 of FIG. 2.

Website user interface 42 includes a plurality of web pages, such as, for example, an “Initial Login Screen.” The Initial Login Screen allows a user to log on to the system with a username and password at which point they are assigned “administrator”, “reseller”, or “customer” status on the accessibility service. The following process is used to allow a user to enter the server application 300. Initially, a customer requests a trial activation of the accessibility service for their website. The login username and password are then matched against the enabled sites database 50. If the user is present within the customer database 48, the user will be assigned administrator, reseller or customer status. If no details exist, the user is not be permitted access to the server application 300.

The Website User Interface 42 further includes a resellers screen. The resellers screen is only available to users with administrator status and allows the administrator to add or modify a reseller and their details on the accessibility service. A customers screen is also provided and is only available to users with administrator or reseller status. The customers screen allows administrators and resellers to add or modify customer details on the accessibility service. The customer screen also allows the reseller to add further websites to a customer record.

The following business process will be used to activate a website on the accessibility service. Initially, a customer requests a trial activation of the accessibility service for their website. The customer details are then entered into the customer database 48. Associated website details are also entered into the enabled site database 50. These details include, for example, the date of expiry on the service (typically 14 days from the initial request) and the features to be disable or enabled according to customer preference. A website activation mechanism 46 notices a change in the customer and/or enabled site databases 48, 50 and outputs a new site activation file for subsequent download to clients, therefore activating the website on the service when the client requests verification of a website/webpage activation thereon.

Website user interface 42 further includes an accessibility details screen. The accessibility details screen allows administrators, resellers, and customers to change the settings (e.g., pronunciations, voice used, etc.) for the accessibility services delivered to activated websites The website user interface 42 also includes an expiring URLs screen and an expired URLs screen which can be used to notify customers that their subscription has or is about to expire.

Although the illustrative embodiment of the method and apparatus is described herein as including certain components and process steps, it should be appreciated by those skilled in the art that the functionality described herein may be divided up in to different components and provided in different steps.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An online, subscription-based accessibility application for client-based speech enabling of content at a website, comprising:
a server application for converting word representations into corresponding speech representations;
a client application networked with the server application and including user controls for controlling said word-to-speech conversion according to a plurality of user control features; and
a speech engine for speaking text on a webpage of the website.

2. The application of claim 1 wherein the text on the webpage is spoken continuously without any user interaction.

3. The application of claim 1 wherein the user highlights text to be spoken by moving a pointer over the text.

4. The application of claim 3 wherein a stream of text is highlighted with a first color and each word within the text stream is highlighted with a second color different that the first color as that word is being spoken.

5. The application of claim 4 wherein the colors used to highlight text are definable by the user.

6. The application of claim 1 wherein static and dynamic content on the webpage is spoken on the fly without using pre-recorded sound files.

7. The application of claim 1 wherein new content is spoken automatically when the website is updated.

8. The application of claim 1 wherein the language in which the text is spoken is one of Dutch, French, Spanish, German, Italian, Japanese, Korean, Portuguese or Russian.

9. The application of claim 1 wherein the user controls the pitch, speed and volume of speech spoken.

10. The application of claim 1 wherein the user can specify the gender and the nationality of voices used for speaking.

11. The application of claim 1 wherein the user controls pronunciation of the text.

12. The application of claim 1 wherein a subscriber is able to modify pronunciations for all users and/or define a preferred voice or language for a given URL.

13. The application of claim 1 wherein the speech engine is able to speak content of drop down lists and text boxes on the webpage.

14. The application of claim 1 wherein when a user browses to a speech enabled website, the client application:
retrieves the URL of the website;
determines whether the retrieved URL matches a URL listed in a database downloaded from the server application, and
if a match if found, activates a voice engine to be used to one of a website owner's preference or that of the user, or
if no match is found, disables the speech engine from speaking content of the website.

15. A method for speech enabling web content, comprising the steps of:
highlighting text displayed on a webpage by moving a pointer over the text;
converting the highlighted text into corresponding speech representations;
controlling said text-to-speech conversion according to a plurality of user control features; and
speaking the highlighted text.

16. The method of claim 15 further including the step of:
inserting bookmarks before each word of the highlighted text, each bookmark including an ID tag for marking the word's position in a sentence,
wherein a first bookmark indicates a first word in the sentence and a second bookmark indicates a second word in the sentence.

17. A business method for providing speech enabled web content at one or more websites belonging to each of a plurality of subscribers, the method comprising the steps of:
alerting each of plurality of visitors upon reaching the website that the content is speech enabled; and
directing the visitor to a download location on the website and allowing the visitor to download plug-in software;
wherein when the visitor returns to the website, the software automatically detects the website URL and switches on a speech enabling application.

18. The business method of claim 17 wherein there is zero bandwidth impact after the user download.

19. The business method of claim 17 wherein the subscriber pays an annual fee to speech enable their website and the visitor is not charged a fee for the download.

20. The business method of claim 17 wherein the plug-in software is downloaded in a single step.

21. An online accessibility application for client-based speech enabling of web content, comprising:
a server application for converting word representations into corresponding speech representations; and
a client application networked with the server application and including user controls for controlling said word-to-speech conversion,
the client application including a pronunciation function for modifying pronunciation of respective word representations.

22. The accessibility application recited in claim 21 wherein the pronunciation function determines whether a pronunciation file contains an alternative pronunciation for a first word representation.

23. The accessibility application recited in claim 22 wherein if the pronunciation file contains an alternative pronunciation for the first word representation, the pronunciation function exchanges a default pronunciation for the first word representation with the alternative pronunciation.
